(19) United States
(12) Patent Application Publication
(10) Pub. No.: US 2011/0164559 A1
(43) Pub. Date: Jul. 7, 2011

(54) CELLULAR AND LANDLINE INTERFACE TO CORDLESS CALL ROUTING SYSTEM

(76) Inventor: Michael Bamidele, Kent (GB)

(21) Appl. No.: 12/916,996

(22) Filed: Nov. 1, 2010

(30) Foreign Application Priority Data
Jan. 4, 2010 (GB) GB1000052.9
Feb. 2, 2010 (GB) GB1001615.2

(51) Int. Cl. H04W 40/00; H04L 12/66

(52) U.S. Cl. 370/328; 455/426.1

(57) ABSTRACT

A method and system are provided for routing multiple communications sessions. One or more communication devices are paired to an access point having control circuitry for processing multiple concurrent communication sessions. Communications pertaining to a communication device are routed through the access point to a terminal. Additionally, communications pertaining to a terminal are routed through the access point to a communication device.

### TECHNICAL FIELD OF THE INVENTION

The present invention generally relates to routing multiple communication sessions within a local area such as a home or apartment. More specifically, the present invention relates to a system and method for routing communications between one or more communication devices and one or more terminals within a home, apartment, office, or the like.

### BACKGROUND OF THE INVENTION

The increasing availability and proliferation of mobile communication devices has created a shift in many individuals' communication tendencies. In the past, most people maintained a fixed telephone line as their primary source for communication. However, with the advent of mobile communication devices such as cellular phones, the increase in cellular coverage and call quality coupled with decreasing cellular rates and fees has resulted in many individuals now regarding their personal mobile communication device (such as a cellular phone or smartphone) as their primary source of communication.

This increasing reliance on mobile communication devices has resulted in several challenges and problems. Firstly, most, if not all, mobile communication devices receive their power from rechargeable batteries. Accordingly, these devices need to be plugged in at regular intervals in order to recharge. As a result, the mobile nature and convenience of the device is often temporarily suspended, or at least hampered, while the device is being charged.

Furthermore, the nature and practical truth of cellular communication today is that cellular coverage is uneven or inconsistent. As a result, one area or room may provide satisfactory cellular reception, while another area has inconsistent reception or no coverage at all. Additionally, various electric and electronic devices can emit radiation that can interfere with cellular signals.

Moreover, many questions have been raised regarding levels of radiation that are emitted by various mobile communication devices and the antennas they incorporate. Cellular phones are of particular concern, in light of the fact that users hold these devices in close proximity to their heads while talking.

Finally, the nature of mobile communication has necessitated the creation of small, highly portable communication devices. While these portable devices are convenient to transport and store, their small size, buttons, etc., can also be inconvenient for many users. These mobile devices are also generally quite expensive, and prolonged use of them only increases the likelihood of damage or malfunction.

It is with respect to these considerations and others that the disclosure made herein is presented

### SUMMARY OF THE INVENTION

Technologies are presented herein for routing multiple communications sessions. According to one aspect, a method for enabling concurrent communication over a network is provided. One or more communication devices are connected to an access point having control circuitry for processing multiple concurrent communication sessions. Communications pertaining to a communication device are routed through the access point to a terminal. Additionally, communications pertaining to a terminal are routed through the access point to a communication device.

According to another aspect, a communication routing system is provided. The communication routing system includes an access point capable of communication with one or more communication devices and one or more terminals. In operation, the access point routes communications pertaining to a communication device to a terminal and communications pertaining to a terminal to a communication device.

According to yet another aspect, a communication routing system is provided. The communication routing system includes an access point capable of wireless communication with one or more cellular communication devices and one or more terminals. The access point also has control circuitry for processing multiple concurrent communication sessions. In operation, the access point routes communications pertaining to a cellular communication device to a terminal and communications pertaining to a terminal to a cellular communication device.

These and other aspects, features, and arrangements can be better appreciated from the accompanying description of the drawing figures of certain embodiments of the invention.

### BRIEF DESCRIPTION OF THE DRAWINGS

FIG. 1 is a high-level diagram illustrating an exemplary configuration of an access point connected to various communication devices and terminals.

FIG. 2 is a flow diagram illustrating a method for enabling concurrent communication over a network, in accordance with exemplary embodiments thereof.

### DETAILED DESCRIPTION OF CERTAIN EMBODIMENTS OF THE INVENTION

The following detailed description is directed to methods and systems for enabling concurrent communication over a network. References are made to the accompanying drawings that form a part hereof, and which are shown by way of illustration through specific embodiments, arrangements, and examples.

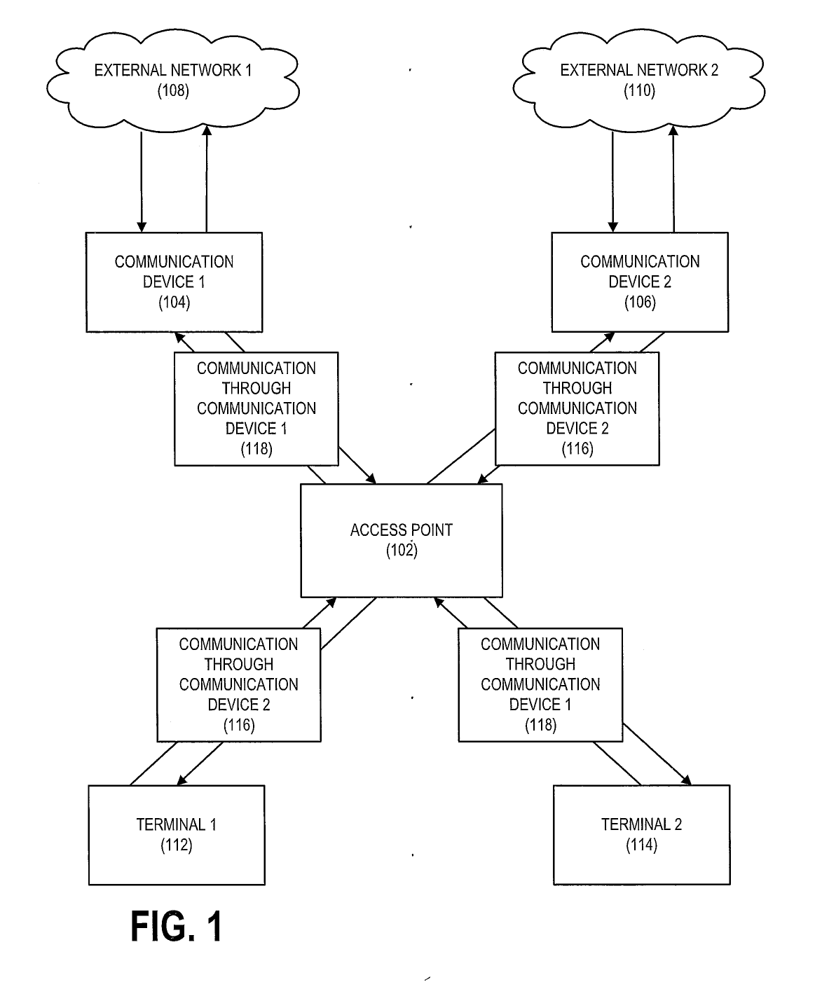

Referring now to the drawings, it is to be understood that like numerals represent like elements through the several figures, and that not all components and/or steps described and illustrated with reference to the figures are required for all embodiments or arrangements. FIG. 1 is a high-level diagram illustrating an exemplary configuration of an access point 102 in communication with various communication devices 104, 106 and terminals 112, 114. The access point 102 includes control circuitry, a processor, and one or more software modules stored in memory which can be executed by the processor. The access point also includes various interfaces which allow it to communicate with various communication devices and terminals, as will be described in greater detail below. The access point also can have an IP address that allows it to be accessed for administrative- and user-interface purposes using a conventional computer, netbook, tablet or other device connected to a network. The access point includes code executing in its processor and operative to present setting information to the user and to accept and store values for the settings.

Various communication devices 104, 106 can connect to access point 102. Communication devices 104, 106 can include, but are not limited to, cellular phones, smartphones, personal digital assistants (“PDAs”), handheld gaming devices, and mobile computing devices. The communication devices 104, 106 are configured to initiate and maintain communication with one or more external networks 108, 110. External networks 108, 110 can include, but are not limited to, cellular voice and/or data networks such as CDMA, TDMA and GSM networks, wireless networks, and wired networks. The connection to external networks 108, 110 enables communication devices 104, 106 to engage in voice and/or data communication, including cellular phone calls, SMS and MMS messaging, and/or data transmissions using known protocols (e.g., email via SMTP).

Communication devices 104, 106 can connect to access point 102 in a variety of ways. In one embodiment, the communication devices 104, 106 connect to access point 102 through an interface such as Bluetooth®. It should be appreciated that in other embodiments various interfaces may be utilized, such as wireless or wired links. The connection of the communication devices 104, 106 with access point 102 is central to the access point 102 being able to handle communications to and from one or more external networks 108, 110, as will be described in greater detail below.

Also connected to access point 102 are one or more terminals 112, 114. In one arrangement, terminals 112, 114 are traditional corded or cordless telephones. Among known cordless phones are those that transmit in the high-megahertz range (e.g. 900 MHz) or low gigahertz range (e.g., 1.2 to 5.8 GHz). In another arrangement, terminals 112, 114 comprise communication headsets. It will be appreciated, however, that the terminals can take on a variety of forms so long as they are capable of at least audio communication between at least two parties. Thus, for example, in one particular arrangement the terminals comprise suitably configured personal computers and videophones. The terminals 112, 114 can be fixed communication stations, or portable. By way of example, each of the various terminals 112, 114 can be associated with a specific location or room in an office or house, or can have a charging base associated with such location.

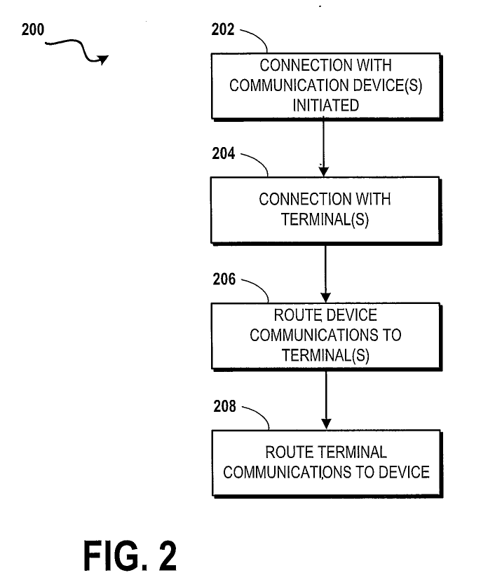

Turning now to FIG. 2, a flow diagram is described showing a routine 200 that illustrates a broad aspect of a method for enabling concurrent communication over a network in accordance with at least one embodiment disclosed herein. It should be appreciated that several of the logical operations described herein are implemented (1) as a sequence of computer implemented acts or program modules running on the access point 102 and/or (2) as interconnected machine logic circuits or circuit modules within the access point 102. The implementation is a matter of choice dependent on the performance and other requirements of the device. Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The routine 200 begins at block 202 where the access point 102 initiates a connection with one or more communication devices 104, 106. By way of example, the access point 102 can constantly broadcast an invitation signal which makes the access point's 102 availability detectable by any communication device. In an alternative arrangement, the access point 102 can broadcast an invitation signal upon the detection of one or more communication devices 104, 106 within range, or only to devices having a MAC address that is stored within the access point. Upon receipt of the invitation signal, communication device 104, 106 can alert and/or notify its user that access point 102 as available for connection. The user of the communication device 104, 106 can then be presented with the option to connect to access point 102. In an alternative arrangement, the communication device 104, 106 can be configured to automatically connect to a particular access point 102 and no other, or to any access point within range. Once the communication device 104, 106 has connected with the access point 102, the access point is configured to control any aspect of communication to and from the communication device 104, 106, or a define subset of communications to and from the communication device 104, 106, as will be described in greater detail below.

Such connections are referred to herein as “pairings.” When the communication devices 104, 106 are Bluetooth® compatible devices, the access point “pairs” with each communication device, but none of the communication devices pair with each other. Pairs can be established using Bluetooth circuitry within the access point 102 and the communication devices in a conventional way.

From operation 202, the routine 200 can proceed to operation 204, where the access point 102 connects with one or more terminals 112, 114, and in so doing establishes itself as a router for two-way communications between plural communication devices 104, 106, etc. on the one hand and plural terminals 112, 114, etc. on the other hand.

As referenced above, the terminals 112, 114 are preferably fixed communication stations such as corded or cordless telephones. Upon the connection of a communication device 104, 106 with the access point 102, the access point 102 utilizes its control circuitry and/or its processor executing one or more software modules to route incoming and outgoing calls to particular ones of the connected communication device 104, 106 and the terminals 112, 114.

According to one arrangement, once the access point 102 has connected with a communication device 104, 106, either the access point, or a machine connected to the access point (e.g., as anode on a network), or one of the terminals can provide a selection of available communication devices 104, 106 to which a given terminal 112, 114 can connect. The terminals can be identified by room name (such as office, living room, bedroom, etc.), location (such as next to front door, in hallway, etc.), or any other such identification means. The selection enables the user to identify which terminals 112, 114 can connect to and communicate through which ones of the communication device 104, 106. Thus, as can be appreciated, a given terminal can have access to as many outside communication paths through the access point 102 as there are paired communication devices at any given moment. If a family has three cellular phones and all are paired to the access point 102, then a terminal 112 can have up to three separate lines to make a call or on which to receive a call (excluding call waiting which is in addition). If one family member is out, and there are only two phones paired at that moment to the access point, then there are two separate lines to make a call or on which to receive a call. A call is placed, if initiated by a given terminal, through an available, paired communication device. In this regard, “available” means that the communication device has connectivity to the external network 108, 110, and the device is not already in the process of a call setup and connection.

As will be appreciated, the routing of calls whether incoming or outgoing is managed by code executing in the processor of the access point. The code can dynamically establish a routing path between a particular one of the communication devices and at least one of the terminals, or a particular one of the terminals to one of the communication devices. The routing path is maintained by the access point for the duration of the call. In the event that the communication device used for a particular active call receives a call waiting signal, that signal can be passed through to and played at the speaker of the terminal 112, 114 that is being used for the active call.

From operation 204, the routine 200 can proceed to operation 206, where the access point 102 routes communications 116, 118 pertaining to a communication device 104, 106 to a terminal 112, 114. In doing so, the access point 102 enables a user to harness the ability of a communication device 104, 106 to communicate with various external networks 108, 110, together with the convenience of a fixed communication terminal 112, 114.

By way of illustration, with reference to FIG. 1, communication device 104 can pair with access point 102 and be connected to terminal 114. When communication device 104 receives a telephone call through its connection to external network 108, this communication 118 can be routed from communication device 104 through access point 102 to terminal 114.

From operation 206, the routine 200 can proceed to operation 208, where the access point 102 routes communications 116, 118 pertaining to a terminal 112, 114, to a communication device 104, 106. In doing so, the access point 102 enables a user to harness the ability of a communication device 104, 106 to communicate with various external networks 108, 110, together with the convenience of a fixed communication terminal 112, 114.

By way of illustration, with reference to FIG. 1, terminal 112 is connected to access point 102 and a call can be routed to communication device 106. When terminal 112 initiates a telephone call through access point 102, the communication 116 can be routed from terminal 112 through access point 102 to communication device 106. In doing so, the call can be placed through communication device's 106 connection with external network 110.

It should be noted that while the foregoing examples have principally illustrated scenarios wherein a singular communication device 104, 106 is configured to connect to a singular terminal 112, 114, various other arrangements are also possible. For example, access point 102 can route a single communication device 104, 106 to multiple terminals 112, 114. In such an arrangement, when a call from an external network 108, 110 is received by a particular communication device 104, 106, multiple terminals 112, 114 can ring and allow users to accept the call through any, or a selection, of the terminals 112, 114. For example, any call received at the communication device 104 can be routed to all terminals 112, 114, etc, or to multiple, selected terminals. The particular associations can be managed through a user interface of the access point, as described above. In another example, access point 102 can connect a single terminal 112, 114 with multiple communication devices 104, 106. In such an arrangement, when a user tries to place a call from the terminal, the access point routes the dialed number to the external network 108, 110 of an available communication device 104, 106. In an alternate arrangement, when placing an outgoing call from a terminal 112, 114 that is associated with more than one communication device 104, 106, the user is prompted to specify through which communication device 104, 106, the communication should be routed. In this regard, each terminal can have a preference stored to inform the access point of a preferred communication device to use for a call, or a button sequence can be pressed (e.g., press a key from 1-9 before pressing the “Talk” or “Off Hook” button.

Various other features and functionalities that enhance the operation of the access point 102, communication devices 104, 106 and terminals 112, 114 are also provided. For example, the access point 102 preferably includes code executing in its onboard processor that enables unique ring tones and chimes to be assigned to communications 116, 118 pertaining to specific communication devices 104, 106. In such an arrangement, when a call to a specific communication device 104, 106 is received, the unique ringtone assigned to the specific communication device 104, 106 is played by the one or more of the terminals 112, 114 that are associated with that communication device 104, 106. In doing so, users are able to easily and immediately identify the origin of an incoming call being routed to a terminal 112, 114 without using their communication device, but rather while using a more convenient or different form factor associated with the terminals 112, 114. This feature is particularly useful in scenario described above wherein multiple communication devices 104, 106 are paired with a single terminal 112, 114. In part, this functionality can support a pass through of ring tones associated with the calling party, with the tone being conveyed through the pairing of the communication device 106, 108 to the access point 102 and on to selected ones of or all of the terminals 112, 114, etc.

While the foregoing description has focused primarily on the routing of telephone calls to and from communication devices 104, 106 and terminals 112, 114, it should be noted that the various features and functionalities described herein can be similarly applied to other forms of communication such as email, SMS and MMS messaging, and video-based communications. In one embodiment, various terminals 112, 114 can have the capacity to receive and/or compose and send email. Accordingly, when a specific terminal 112, 114 is connected to one or more communication devices 104, 106 through the access point, the access point 102 can route email communications pertaining to the paired communication device(s) 104, 106 to the associated terminal 112, 114. Similarly, users may utilize the terminal 112, 114 to compose and send email to be routed through the access point to the paired communication device(s) 104, 106. In an arrangement where one or more of the terminals 112, 114 incorporate video capture and/or video display equipment, video-based communication (such as video-calling and/or video-conferencing) can be routed through one or more communication devices 104, 106 in a substantially similar fashion.

It should be further understood that while various of the embodiments, arrangements, and examples described herein have referred to a singular instance of routing communications between a communication device 104, 106 and a terminal 112, 114, the access point 102 is capable of routing multiple concurrent communications between multiple communication devices and terminals simultaneously. By way of example, an access point 102 can serve the needs of various members of a family. Each member of the family can pair his or her own personal communication device 104, 106 with the access point 102 and associate his or her personal device with one or more of the terminals 112, 114. In doing so, the access point 102 can route communications between the various communication devices 104, 106 and the various terminals 112, 114 simultaneously.

Additionally, the access point can create and store various user profiles corresponding to previously established connection and pairing preferences. By way of example, access point 102 can create and store a connection profile that dictates that when a specific communication device 104, 106 is paired to the access point, that device is to be associated with a specific terminal 112, 114. In a similar fashion, user profiles for the various connected terminals 112, 114 can be created and stored. Such a user profile can dictate that a specific terminal 112, 114 is to use a specific communication device 104, 106 by default for outbound communication.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A method for enabling concurrent Communications over a network, the method comprising:
pairing one or more communication devices to an access point having control circuitry for processing multiple concurrent communication sessions;
routing communications pertaining to a particular one of the communication devices through the access point to one or more associated terminals; and
routing communications pertaining to a particular terminal through the access point to an available communication device.

2. The method of claim 1, further comprising:
associating one or more terminals with the access point.

3. The method of claim 1, further comprising:
associating a unique tone with a communication device.

4. The method of claim 1 wherein the communication devices are cellular phones.

5. The method of claim 1 wherein the communications pertaining to a communication device and the communications pertaining to a terminal are telephone calls.

6. A communication routing system connected between one or more communication devices and one or more terminals, comprising:
an access point having a processor and code executing therein, the code configuring the access point to dynamically establish communication between the one or more communication devices and the one or more terminals, wherein the code is configured to route for the duration of a call:
communications pertaining to a particular one of the communication devices to at least one of the terminals, and
communications pertaining to a particular one of the terminals to one of the communication devices.

7. The system of claim 6, wherein the access point pairs to the one or more communication devices and remains concurrently paired to the one or more communication devices.

8. The system of claim 6, wherein the access point associates a unique tone with a communication device.

9. The system of claim 6, wherein the access point includes one or more software modules encoded on a storage medium that execute on the processor.

10. The system of claim 9, wherein the software modules, when executed on the processor, enable the access point to route communications between a particular communication device among the one or more communication devices and a particular terminal among the one or more terminals.

11. The system of claim 6, wherein the access point routes communications pertaining to a single communication device to one or more terminals.

12. The system of claim 6 wherein the access point routes communications pertaining to a single terminal to one or more communication devices.

13. A communication routing system connected between one or more cellular communication devices and one or more terminals, comprising:
an access point having a processor and code executing therein, the code configuring the access point to dynamically establish wireless communication with the one or more cellular communication devices and the one or more terminals, the access point having control circuitry for processing multiple concurrent communication sessions, wherein the code is configured to route for the duration of a call:
communications pertaining to a particular one of the cellular communication devices to at least one of the terminals, and
communications pertaining to a particular one of the terminals to one of the cellular communication devices.

14. The system of claim 13, wherein the access point pairs to the one or more cellular communication devices and remains concurrently paired to the one or more communication devices.

15. The system of claim 13, wherein the access point includes one or more software modules encoded on a storage medium that execute on the processor.

16. The system of claim 15, wherein the software modules, when executed on the processor, enable the access point to route communications between a particular cellular communication device among the one or more cellular communication devices and a particular terminal among the one or more terminals.

17. The system of claim 13, wherein the access point routes communications pertaining to a single cellular communication device to one or more terminals.

18. The system of claim 13 wherein the access point routes communications pertaining to a single terminal to one or more of the cellular communication devices.

19. The system of claim 13, wherein the access point routes a plurality of communications between a plurality of the cellular communication devices and a plurality of the terminals substantially simultaneously.
